(19) United States
(12) Patent Application Publication
(10) Pub. No.: US 2022/0231598 A1
(43) Pub. Date: Jul. 21, 2022

(54) POWER TRANSITIONING CIRCUIT FOR DC-DC CONVERTER

(71) Applicant: Murata Manufacturing Co., Ltd., Nagaokakyo-shi, Kyoto-fu (JP)

(72) Inventors: Rubinic JAKSA, Markham (CA); Anil YARAMASU, Markham (CA); Bing GONG, Markham (CA)

(21) Appl. No.: 17/613,787

(22) PCT Filed: May 13, 2020
(86) PCT No.: PCT/US2020/032551

§ 371 Date: Nov. 23, 2021

Related U.S. Application Data
(60) Provisional application No. 62/863,884, filed on Jun. 20, 2019.

(51) Int. Cl. H02M 1/32; H02J 9/06; H02M 1/00; H02M 3/158; H02M 1/08

(52) U.S. Cl. CPC H02M 1/32; H02J 9/061; H02M 1/08; H02M 3/158; H02M 1/0006; H02M 1/008

(57) ABSTRACT

A power supply circuit includes a first direct-current to direct-current (DC-DC) converter circuit connected to a first load via a first bidirectional switch; a second DC-DC converter circuit connected to a second load and connected, via a second bidirectional switch, to the first load; and a control circuit that turns ON and turns OFF the first bidirectional switch and the second bidirectional switch in a complementary manner.

### CROSS REFERENCE TO RELATED APPLICATIONS

This application claims the benefit of U.S. Patent Application Ser. No. 62/863,884 filed on Jun. 20, 2019. The entire contents of this application are hereby incorporated by reference.

### BACKGROUND OF THE INVENTION

### 1. Field of the Invention

The present invention relates to DC-DC converter power supplies. More specifically, the present invention relates to power transitioning circuits that can transition power between an auxiliary converter and a main converter of a DC-DC converter while providing rapid-response fault protection.

### 2. Description of the Related Art

Known power supplies have the ability to provide relatively low power in an auxiliary stand-by (house-keeping) output mode in addition to providing main power. This usually necessitates that the power supply is equipped with two DC-DC converters: a low-power DC-DC converter and a main DC-DC converter that is powered up by an external signal.

The low-power DC-DC converter circuit of the known power supplies can have a number of topologies, with flyback being a common choice for most designers due to its simplicity, low cost, and reliability. However, the efficiency of the low-power flyback converter is usually lower than that using a fully resonant topology, considering that the main DC-DC converter is designed to be more efficient than the low-power DC-DC converter.

In another example described in U.S. Patent Application Publication No. 2010/0109433, power is allocated between an auxiliary power supply module and a main power supply module using one active power switch and a passive diode. When the auxiliary power supply module provides power, the passive diode has a voltage drop, which is typically about 0.7 V, decreasing the efficiency of the converter. The voltage of the auxiliary power supply module is required to be lower than the voltage of the main power supply module. In U.S. Patent Application Publication No. 2010/0109433, transistors Q2 and Q4 are cascoded, i.e., transistors Q2 and Q4 are stacked vertically with the collector of transistor Q2 connected to the emitter of transistor Q4. The configuration in U.S. Patent Application Publication No. 2010/0109433 is adequate for driving a single power MOSFET Q₁ but would not be sufficient if diode D1 was replaced with another MOSFET. The control of two bidirectional switches, such as MOSFETs, is more complex and requires different operating conditions to be considered.

### SUMMARY OF THE INVENTION

To overcome the problems described above, preferred embodiments of the present invention provide DC-DC converters each including an additional circuit to transition power delivered to an auxiliary load from an auxiliary low-power converter to a main power converter. Precise turn on/off timing of a shutdown signal is used to operate two bidirectional switches to reduce or minimize transition time and prevent power flow in a wrong direction. Using two bidirectional switches provides better efficiency than a switch and a diode of the related art. Additionally, a voltage drop of 0.7V is avoided when an auxiliary power supply provides power to the load.

Unlike the related art, in preferred embodiments of the present invention, there is no requirement that the output voltage of the main converter is higher than the output voltage of the auxiliary converter. In addition, a reduction in cost is possible, because secondary synchronous rectifiers along with their control circuitry can be eliminated from the auxiliary converter.

According to a preferred embodiment of the present invention, a power supply circuit includes a first direct-current to direct-current (DC-DC) converter circuit connected to a first load via a first bidirectional switch; a second DC-DC converter circuit connected to a second load and connected, via a second bidirectional switch, to the first load; and a control circuit to turn ON and turn OFF the first bidirectional switch and the second bidirectional switch in a complementary manner.

The first and second bidirectional switches are preferably metal-oxide-semiconductor field effect transistors. A drain of the first bidirectional switch is preferably connected to a drain of the second bidirectional switch. The control circuit preferably includes four transistors.

The power supply circuit further preferably includes a protection circuit to output a shutdown signal to the control circuit. Preferably, the shutdown signal turns ON the first bidirectional switch and turns OFF the second bidirectional switch.

The power supply circuit further preferably includes a microcontroller to output a control signal to the control circuit. Preferably, the control signal turns OFF the first bidirectional switch and turns ON the second bidirectional switch.

Preferably, the control circuit includes a power supply voltage, a first transistor connected between the power supply voltage and ground, and a second transistor connected between the power supply voltage and ground; a drain of the first transistor, a gate of the second transistor, and a gate of the first bidirectional switch are connected to each other and to the power supply voltage; a drain of the second transistor and a gate of the second bidirectional switch are connected to each other and to the power supply voltage; and the first transistor is turned ON and OFF such that the first and second bidirectional switches are turned ON and OFF in the complementary manner. The power supply circuit further preferably includes a microcontroller that outputs a control signal to turn ON and OFF the first transistor. Preferably, the control circuit further includes third and fourth transistors; gates of the third and fourth transistors are connected together; a drain of the third transistor is connected to a gate of the first transistor; a drain of the fourth transistor is connected to the drain of the second transistor; and the third and fourth transistors are turned ON and OFF together such that the first and second bidirectional switches are turned ON and OFF in the complementary manner. The power supply circuit further preferably includes a protection circuit that outputs a shutdown signal to turn ON and OFF together the third and fourth transistors.

The above and other features, elements, steps, configurations, characteristics and advantages of the present invention will become more apparent from the following detailed description of preferred embodiments of the present invention with reference to the attached drawings.

### BRIEF DESCRIPTION OF THE DRAWINGS

FIG. 1 is a circuit diagram of a power transitioning circuit.

FIGS. 2 and 3 are diagrams of signal waveforms to operate the circuit shown in FIG. 1.

### DETAILED DESCRIPTION OF PREFERRED EMBODIMENTS

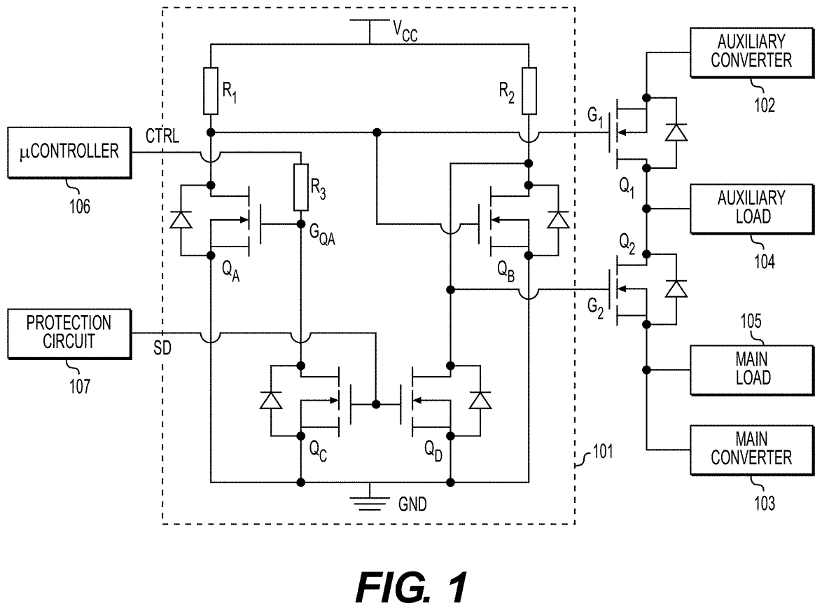

Preferred embodiments of the present invention will now be described in detail with reference to FIGS. 1-3. Note that the following description is in all aspects illustrative and not restrictive and should not be construed to restrict the applications or uses of preferred embodiments of the present invention in any manner.

FIG. 1 is a circuit diagram of a power transitioning circuit for a DC-DC converter. In contrast to power transitioning circuits of the related art, the circuit shown in FIG. 1 includes two bidirectional switches controlled by precise turn on/off timing to reduce or minimize transition times and to prevent power flow in a wrong direction.

The power transitioning circuit of FIG. 1 includes a microcontroller 106 and a protection circuit 107 used to control a control circuit 101. The control circuit 101 controls two power switches Q1 and Q2 that control the power flow between an auxiliary converter 102 and a main converter 103 for an auxiliary load 104. A power supply voltage V_{CC} for the control circuit 101 can be generated from the same source as that used by the auxiliary converter 102 and the main converter 103 and can have any value suitable for the application. A ground connection GND can be shared between the components in FIG. 1. The microcontroller 106 can be any digital device (e.g. DSP, FPGA, etc.) or can be an analog circuit/switch. The protection circuit 107 can be of any type suitable for the application.

As shown in FIG. 1, the control circuit 101 can include four transistors Q_{A}, Q_{B}, Q_{C}, and Q_{D}. As shown, the four transistors Q_{A}, Q_{B}, Q_{C}, and Q_{D} are shown as metal-oxide-semiconductor field effect transistors (MOSFET), but other types of transistors can be used as switches, such as bipolar transistors. Transistors Q_{A} and Q_{B} generate gate signals G₁ and G₂ for power switches Q₁ and Q₂. Further, transistors Q_{C} and Q_{D} can immediately reverse gate signals G₁ and G₂ in case of an emergency shut down when a high-level shutdown signal SD is generated by the protection circuit 107, as discussed in more detail below. The two power switches Q₁ and Q₂ can be included in the power transitioning circuit to deliver power to the auxiliary load 104. The control circuit 101 is used to control the two power switches Q₁ and Q₂ to select the power source connected the auxiliary load 104. As shown in FIG. 1, transistors Q_{A} and Q_{B} are cascaded, i.e., transistors Q_{A} and Q_{B} are connected horizontally so that transistor Q_{A} drives transistor Q_{B}. The arrangement shown in FIG. 1 allows two bidirectional switches, such as power switches Q₁ and Q₂, to be controlled.

The power switches Q₁ and Q₂ shown in FIG. 1 are operated in a complementary manner. The back-to-back configuration of the power switches Q₁ and Q₂ in which the drain of power switch Q₁ is connected to the drain of power switch Q₂ prevents bidirectional power flow between the auxiliary converter 102 and the main converter 103. The default state of the power switches Q₁ and Q₂ after the DC-DC converter is powered up is that power switch Q₁ is enabled and power switch Q₂ is disabled. This allows the power to the auxiliary load 104 to be available when the auxiliary converter 102 is operating, whether or not the main converter 103 is operational.

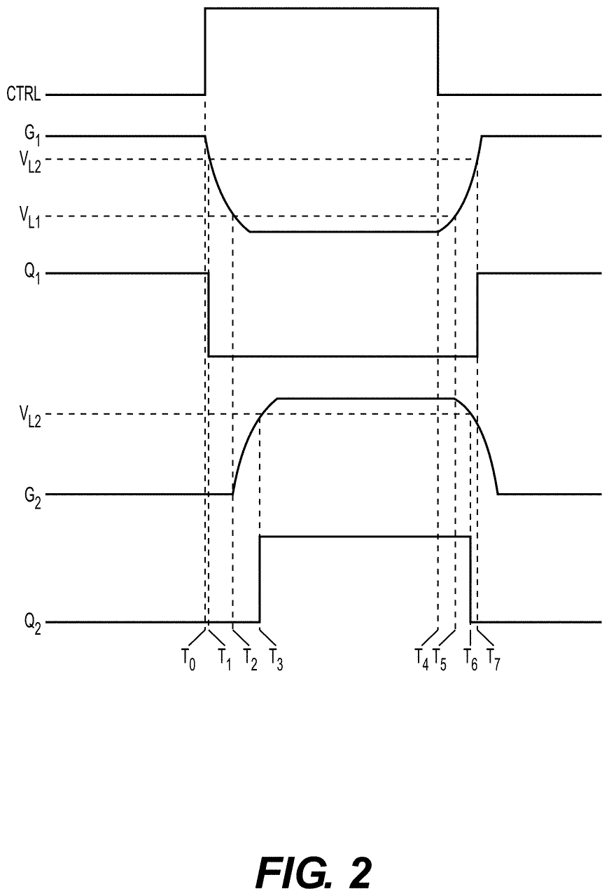

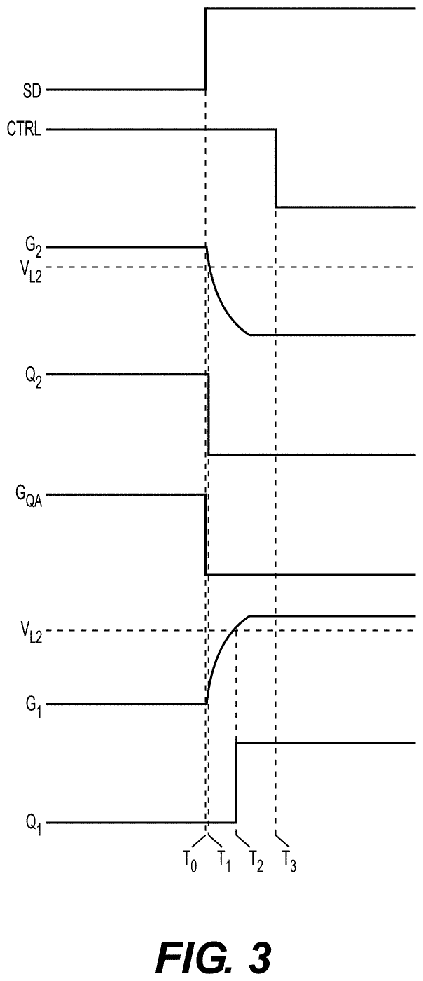

FIGS. 2 and 3 are diagrams of signal waveforms to operate the circuit of FIG. 1. Control signal CTRL and shutdown signal SD can have any suitable voltage levels. FIG. 2 shows signal waveforms of the operating signals during a change of power flow direction. At power up, the control signal CTRL is low, while the microcontroller 106 is initialized. Consequently, the transistor Q_{A} is OFF, and the voltage G₁ is equal to the power supply voltage V_{CC}, thus the voltage G₁ is high. Because the voltage G₁ is high, both the transistor Q_{B} and the power switch Q₁ are ON. Because the transistor Q_{B} is ON, the voltage G₂ is connected to GND, and therefore the power switch Q₂ is OFF. As a result, the auxiliary load 104 is connected to the auxiliary converter 102. The transitioning circuit remains in this state until the main converter 103 is fully operational.

Once the main converter 103 is fully operating, the microcontroller 106 outputs a high control signal CTRL at time T₀ that starts the transition of power from the auxiliary converter 102 to the main converter 103. Due to a non-zero switching time of the transistors and existence of parasitic capacitance, the voltages G₁ and G₂ will respectively exponentially increase or decrease during the transition, as seen in FIG. 2. As transistor Q_{A} turns ON due to a high control signal CTRL, voltage G₁ begins to decrease at the time T₀.

At time T₁, the voltage G₁ has a value V_{L2}, which is smaller than a turn-on gate-source threshold voltage V_{GS} of the power switch Q₁, forcing power switch Q₁ to turn OFF. After time T₁, the voltage G₁ continues to drop and at time T₂ has a value V_{L1}, which represents the gate-source voltage V_{GS} threshold of the transistor Q_{B}. As the voltage G₁ continues to drop, the transistor Q_{B} starts to turn OFF at the same time causing the voltage G₂ to rise. At time T₃, the voltage G₂ reaches value V_{L2}, which is the turn-on threshold voltage of the power switch Q₂, forcing the power switch Q₂ to turn ON. At this time, the power flow transition is completed, and the power to the auxiliary load 104 is re-directed from the auxiliary converter 104 to the main converter 103.

To transition to the auxiliary converter 102, at time T₄ the main converter 103 is switched OFF. Therefore, the microcontroller 106 outputs a low control signal CTRL to reconfigure the power flow from the main converter 103 to the auxiliary converter 104. At time T₄, the transistor Q_{A} starts to turn OFF, which causes the voltage G₁ to rise. When the voltage G₁ reaches value V_{L1} at time T₅, the transistor Q_{B} starts to turn ON, causing the voltage G₂ to drop. The power switch Q₂ turns OFF at time T₆ when the voltage G₂ equals value V_{L2}, which is the gate-source threshold voltage V_{GS} for the power switch Q₂. The voltage G₁ continues to rise, and at time T₇ is equal to value V_{L2}, which is the turn-on gate-source threshold voltage V_{GS} of the power switch Q₁. At this time, the power transition is complete, and the power to the auxiliary load 104 is delivered from the auxiliary converter 102.

FIG. 3 is a diagram of signal waveforms to operate the circuit of FIG. 1. FIG. 3 shows waveforms of operating signals during rapid shut down of the main converter 103. The power to the auxiliary load 104 is supplied from the main converter 103 until a high shutdown signal SD is output by the protection circuit 107. The high shutdown signal SD can be generated due to a fault condition, such as an overload, an overvoltage, an over-temperature, etc. A very fast response can provide better protection. Thus, the protection circuit 107 can be used in parallel with protection implemented in firmware inside the microcontroller 106. This parallel operation can be used because significant delays can exist inside a microcontroller due to scheduled priority for multiple loops that are executed in parallel with limited sampling time capability. This parallel operation allows shutdown to occur faster than if microcontroller 106 uses the shutdown signal SD to change the control signal CTRL to cause shutdown because of additional delays caused by the shutdown signal SD being generated in hardware and sent to the microcontroller 106 to change the control signal CTRL. The additional delays occur because the change in the shutdown signal SD needs to be detected by the microcontroller 106 and then processed through an interrupt routine considering ladder-structured interrupt priorities, after which the microcontroller 106 can change the control signal CTRL. Parallel operation can provide much faster shutdown because, once the fault condition is detected and the high shutdown signal SD is generated, the same shutdown signal SD immediately stops all other hardware modules that the shutdown signal SD is supplied to. The microcontroller 106 can also receive the shutdown signal SD but will process the shutdown signal SD according to the microcontroller's 106 available processing time and then change the control signal CTRL. But the delay in changing the control signal CTRL does not matter because the shutdown signal SD arrived first and has already caused the hardware modules to shut down.

As shown in FIG. 3, initially the control signal CTRL is high, the output power is delivered through the power switch Q₂, and the main converter 103 is operational. At time T₀, the shutdown signal SD becomes high due to triggered hardware protection from the protection circuit 107, and both the transistors Q_{C} and Q_{D} turn ON simultaneously. Because the gate voltage G_{QA} is much lower than the power supply voltage V_{CC}, the gate voltage G_{QA} drops to zero almost immediately, causing the voltage G₁ to rise while the voltage G₂ begins to fall. At time T₁, the voltage G₂ drops to the value V_{L2}, which is the turn-on gate-source threshold voltage V_{GS} of the power switch Q₂, causing the power switch Q₂ to turn OFF. The voltage G₁ continues to rise until time T₂ when it is equal to value V_{L2}, i.e. the turn-on gate-source threshold voltage V_{GS} of the power switch Q₁, causing the power switch Q₁ to turn ON. The power transition is now completed.

Due to a delay caused by sampling and signal processing, the microcontroller 106 outputs a low control signal CTRL at time T₃. However, the gate voltage G_{QA} of the transistor Q_{A} is already pulled down by the transistor Q_{C} from the high shutdown signal SD that turns the transistor Q_{A} OFF. Therefore, the reaction delay of the microcontroller 106 does not adversely affect the operation of the DC-DC converter circuit.

The above-described features and advantages of the preferred embodiments of the present invention are able to be applied to a number of different applications, including, but not limited to, battery chargers, electric vehicle chargers high-voltage data center applications, telecommunications applications, aerospace applications, and the like.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A power supply circuit comprising:
a first direct-current to direct-current (DC-DC) converter circuit connected to a first load via a first bidirectional switch;
a second DC-DC converter circuit connected to a second load and connected, via a second bidirectional switch, to the first load; and
a control circuit to turn ON and turn OFF the first bidirectional switch and the second bidirectional switch in a complementary manner.

2. The power supply circuit according to claim 1, wherein the first and second bidirectional switches are metal-oxide-semiconductor field effect transistors.

3. The power supply circuit according to claim 2, wherein a drain of the first bidirectional switch is connected to a drain of the second bidirectional switch.

4. The power supply circuit according to claim 1, wherein the control circuit includes four transistors.

5. The power supply circuit according to claim 1, further comprising a protection circuit to output a shutdown signal to the control circuit.

6. The power supply circuit according to claim 5, wherein the shutdown signal turns ON the first bidirectional switch and turns OFF the second bidirectional switch.

7. The power supply circuit according to claim 1, further comprising a microcontroller to output a control signal to the control circuit.

8. The power supply circuit according to claim 7, wherein the control signal turns OFF the first bidirectional switch and turns ON the second bidirectional switch.

9. The power supply circuit according to claim 1, wherein:
the control circuit includes:
a power supply voltage;
a first transistor connected between the power supply voltage and ground; and
a second transistor connected between the power supply voltage and ground;
a drain of the first transistor, a gate of the second transistor, and a gate of the first bidirectional switch are connected to each other and to the power supply voltage;
a drain of the second transistor and a gate of the second bidirectional switch are connected to each other and to the power supply voltage; and
the first transistor is turned ON and OFF such that the first and second bidirectional switches are turned ON and OFF in the complementary manner.

10. The power supply circuit according to claim 9, further comprising a microcontroller to output a control signal to turn ON and OFF the first transistor.

11. The power supply circuit according to claim 9, wherein:
the control circuit further includes third and fourth transistors;
gates of the third and fourth transistors are connected together;
a drain of the third transistor is connected to a gate of the first transistor;
a drain of the fourth transistor is connected to the drain of the second transistor; and
the third and fourth transistors are turned ON and OFF together such that the first and second bidirectional switches are turned ON and OFF in the complementary manner.

12. The power supply circuit according to claim 11, further comprising a protection circuit to output a shutdown signal to turn ON and OFF together the third and fourth transistors.
